(19) United States
(12) Patent Application Publication
(10) Pub. No.: US 2012/0253654 A1
(43) Pub. Date: Oct. 4, 2012

(54) CARPOOL ARRANGER AND METHOD OF OPERATION

(75) Inventors: Hung-Min SUN, Hsinchu (TW); Bying-He KU, Hsinchu (TW); Chi-Ming LI, Hsinchu (TW); Chia Yun CHENG, Hsinchu (TW); Xin-Yan YEH, Hsinchu (TW)

(73) Assignee: National Tsing Hua University, Hsinchu (TW)

(21) Appl. No.: 13/155,185

(22) Filed: Jun. 7, 2011

(30) Foreign Application Priority Data
Mar. 30, 2011 (TW) 100110959

(51) Int. Cl. G01C 21/00; G06Q 10/00

(52) U.S. Cl. 701/409; 701/465; 705/7.37

(57) ABSTRACT

The present invention is a carpool arranger and a method of operating the carpool arranger. The carpool arranger comprises at least one passenger internet device, at least one vehicle internet device and a central processing module. The method of operating the carpool arranger comprises steps of transmitting information from each passenger internet device and each vehicle internet device to a central processing module; planning an optimal route for a passenger internet device that transmits a carpool request; choosing appropriate vehicles; planning carpool routes for the chosen vehicles; and transmitting information from the central processing module to each passenger internet device and each vehicle internet device.

### FIELD OF THE INVENTION

The present invention is a carpool arranger and a method for operating the carpool arranger. Specifically, the arranger dynamically updates carpool member pick-up and drop-off points and plans carpool routes for vehicles.

### BACKGROUND OF THE INVENTION

A carpool is an arrangement in which a group of people commute together by vehicle. “To carpool” means to participate in a carpool.

A route is defined by a set of waypoints and has a starting point and an end point.

A carpool comprises a group of passengers that travel together and has a pick-up point, a drop-off point and parameters such as number of passengers, passenger genders, baggage sizes, boarding time, vehicle type preference, etc.

A vehicle is able to carry at least one passenger to a drop-off point and has a route and a status. Statuses include idle, driving passengers with vacancies, driving passengers without a vacancy, etc.

A carpool arranger is an apparatus that has a group of potential passengers and vehicles and plans carpool routes for vehicles based on information about passenger pick-up points, drop-off points and parameters. A carpool arranger increases vehicle utilization, reduces total fuel consumption, reduces travel cost for individual passengers and has become more and more important as environment protection issues become more important.

Conventional carpool arrangers have problems such as:
1. Carpool members must have the same pick-up and drop-off points.
2. Carpool members must submit a request through an Internet platform or a traffic control center. The Internet platform or the traffic control center then assigns vehicles and corresponding passengers to generate the carpool.
3. During the generation of each carpool, route and passengers for each vehicle are determined and remain unchanged. If any vacancy appears in a carpool, it would not be used.

Hence to overcome the foregoing problems is an objective for research.

### SUMMARY OF THE INVENTION

The objective of the present invention is to provide a carpool arranger and a method for operating the arranger that reduces problems of conventional carpool service systems.

The carpool arranger in accordance with the present invention has at least one passenger and at least one vehicle, dynamically updates passenger pick-up points, drop-off points and parameters to plan carpool routes for vehicles and comprises at least one passenger internet device, at least one vehicle internet device and a central processing module. The passenger internet devices and the vehicle internet devices transmit and receive information to and from the central processing module.

The method for operating the carpool arranger in accordance with the present invention comprises steps of transmitting information from each passenger internet device and each vehicle internet device to a central processing module; planning an optimal route for a passenger internet device that transmits a carpool request; choosing appropriate vehicles; planning carpool routes for the chosen vehicles; and transmitting information from the central processing module to the carpool passenger internet devices and the vehicle internet devices.

### BRIEF DESCRIPTION OF THE DRAWINGS

FIG. 1 is a block diagram of an embodiment of the carpool arranger in accordance with the present invention.

FIG. 2 is a flow chart of the method for operating the carpool arranger in accordance with the present invention.

FIG. 3 is a schematic diagram of a route planned by the carpool arranger in accordance with the present invention.

### DETAILED DESCRIPTION OF THE PRESENT INVENTION

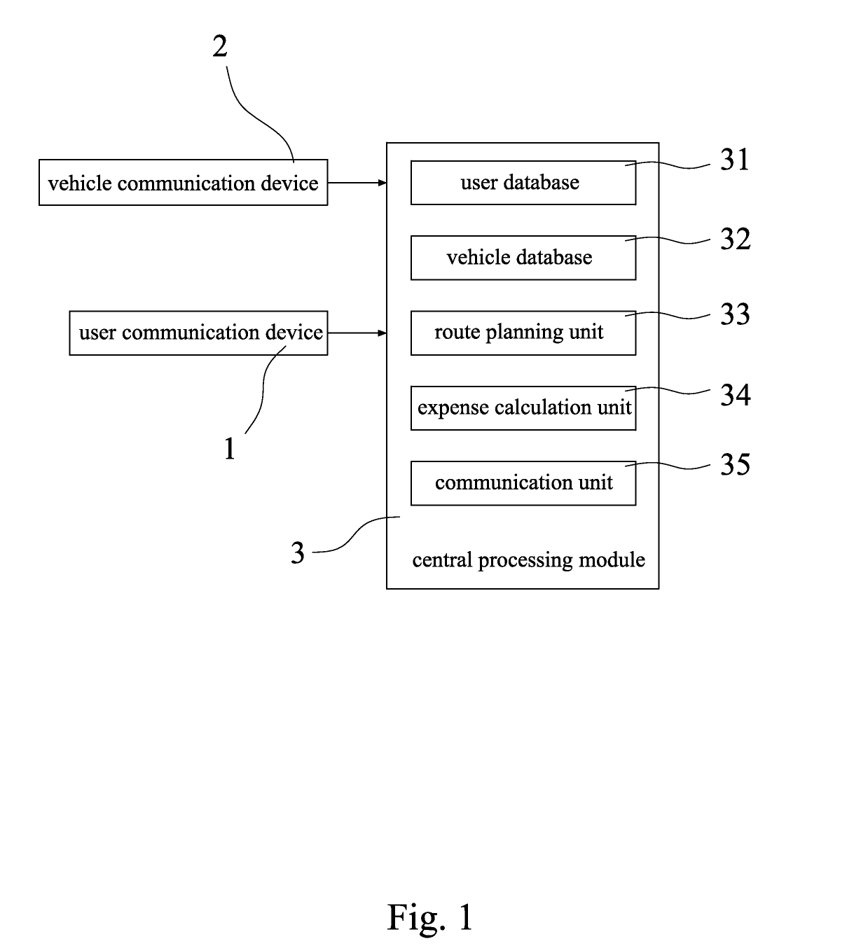

With reference to FIG. 1, a carpool arranger in accordance with the present invention has at least one potential passenger and at least one vehicle and comprises at least one potential passenger internet device (1), at least one vehicle internet device (2) and a central processing module (3).

The at least one potential passenger internet device (1) can be a cellular phone, a computer, an interactive kiosk, etc., is operated by a potential passenger and comprises a global positioning system (GPS) unit and a communication unit. The global positioning system unit calculates a position of the passenger which is treated as the pick-up point of the passenger. The communication unit transmits and receives information to and from the central processing module (3).

The at least one vehicle internet device (2) is near a vehicle, has a map program that is able to generate a route for the vehicle and comprises a global positioning system (GPS) unit and a communication unit. The global positioning system unit calculates a position of the vehicle. The communication unit transmits and receives information to and from the central processing module (3).

The central processing module (3) comprises a passenger database (31), a vehicle database (32), a route planning unit (33), an expense calculation unit (34) and a communication unit (35).

The passenger database (31) records passenger data such as member telephone/cell-phone number, member expense records, etc. and carpool requests, pick-up points, drop-off points and parameters of members.

The vehicle database (32) records positions, statuses and routes of vehicles.

The route planning unit (33) dynamically plans a carpool route for each vehicle such that an original route for each vehicle is a subset of the planned carpool route.

The expense calculation unit (34) calculates a transportation fee for each passenger.

The communication unit (35) transmits and receives information to and from the at least one passenger internet device (1) and the at least one vehicle internet device (2).

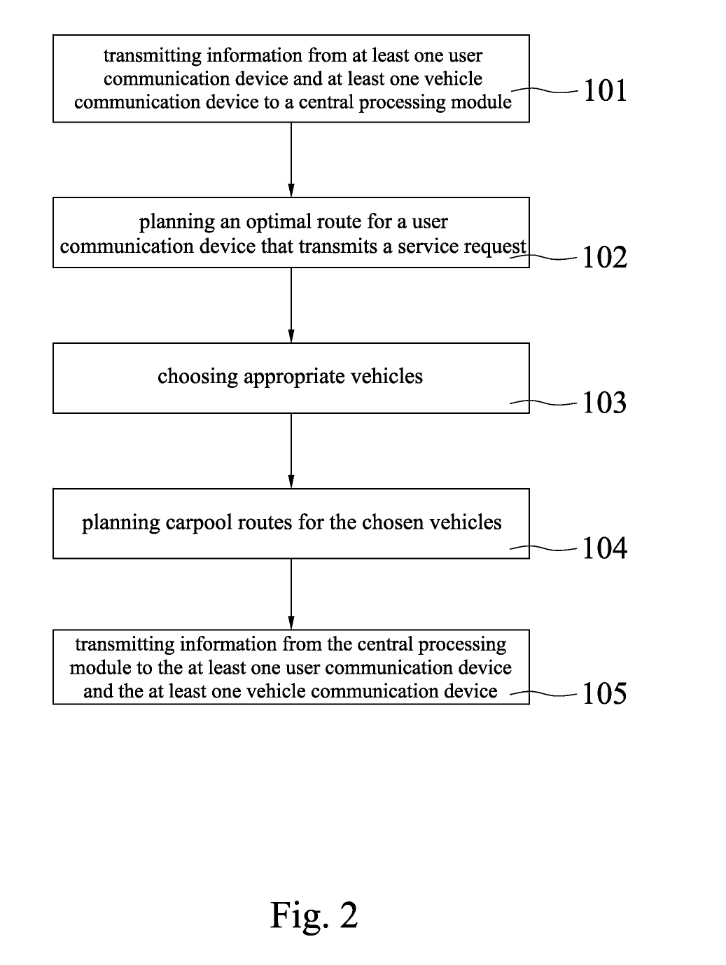

With further reference to FIG. 2, the method for operating the carpool arranger in accordance with the present invention comprises steps of [101] transmitting information from each potential passenger internet device (1) and each vehicle internet device (2) to a central processing module (3), [102] planning an optimal route for a passenger internet device (1) that transmits a carpool request, [103] choosing appropriate vehicles, [104] planning carpool routes for the chosen vehicles; and [105] transmitting information from the central processing module (3) to each potential passenger internet device (1) and each vehicle internet device (2).

Step [101] of transmitting information from each potential passenger internet device (1) and at least one vehicle internet device (2) to a central processing module (3) transmits carpool requests, pick-up points, drop-off points and parameters of potential passengers to the central processing module (3) and transmits vehicle positions and statuses to the central processing module (3).

Step [102] of planning an optimal route for each potential passenger internet device (1) that transmits a carpool request plans a route that has a starting point and an end point being respectively the pick-up point and drop-off point transmitted by the potential passenger internet device (1) and has a minimum route length.

Step [103] of choosing appropriate vehicles chooses vehicles that carry passengers with vacancies and have routes such that each route contains the starting point of the optimal route and coincides with every point in the optimal route until the end point of the route, carry passengers without vacancy and have routes with end points near the starting point of the optimal route; or are idle and have positions near the starting point of the optimal route such that user passenger parameters such as number of passengers and vehicle type preferences transmitted by the user communication potential passenger internet device (1) can be satisfied.

Step [104] of planning carpool routes for vehicles plans a carpool route for each vehicle such that the planned carpool route is a union of the original route of the chosen vehicle, the optimal route and, if the vehicle is carrying passengers without vacancy or is idle, a route connects the end point of the original route and the starting point of the optimal route.

Step [105] of transmitting information from the central processing module (3) to each potential passenger internet device (1) and the at least one vehicle internet device (2) transmits boarding time, boarding position, number of vacancies, vehicle license number, transportation fee, etc. to the passenger internet devices (1) and the planned carpool route, passenger pick-up points, drop-off points and parameters to the vehicle internet device (2).

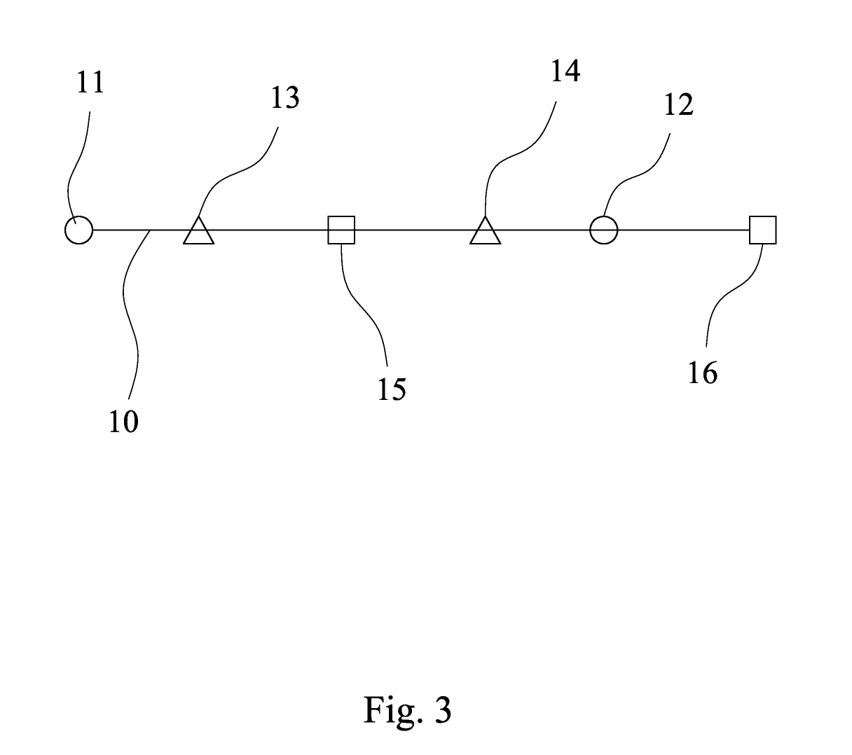

With further reference to FIG. 3, a carpool route planned by the carpool arranger in accordance with the present invention has a first passenger with an pick-up point (11) and a drop-off point (12), a second passenger with an pick-up point (13) and a drop-off point (14) and a third passenger with an pick-up point (15) and a drop-off point (16), and a carpool route (10) is a union of three optimal routes for the first, second and third passenger from pick-up point (11), (13) and (15) to drop-off points (12), (14) and (16), respectively.

What is claimed is:

1. A carpool arranger having at least one potential passenger and at least one vehicle and comprising
at least one potential passenger internet device having a global positioning system unit and a communication unit;
at least one vehicle internet device having a global positioning system unit and a communication unit; and
a central processing module that has a passenger database, a vehicle database, a route planning unit that plans a carpool route for each vehicle such that original route of each vehicle is a subset of the planned carpool route, an expense calculating unit and a communication unit.

2. The carpool arranger as claimed in claim 1, wherein the communication unit of the user communication device transmits information of carpool request and passenger pick-up point, drop-off point and parameters and receives information.

3. The carpool arranger as claimed in claim 1, wherein the communication unit of the vehicle internet device transmits information of vehicle position and status and receives information.

4. The carpool arranger as claimed in claim 1, wherein the passenger internet device is a cell-phone.

5. The carpool arranger as claimed in claim 1, wherein the passenger internet device is a computer.

6. The carpool arranger as claimed in claim 1, wherein the passenger internet device is an interactive kiosk.

7. The carpool arranger as claimed in claim 1, wherein the passenger database records passenger telephone/cell-phone number, passenger expense records, carpool requests and passenger pick-up point, drop-off point and parameters.

8. The carpool arranger as claimed in claim 1, wherein the vehicle database records vehicle position, statuses and routes.

9. The carpool arranger as claimed in claim 1, wherein the communication unit of the central processing module transmits information of boarding position, boarding time, transportation fee, number of vacancies to each passenger internet device and transmits information of route and user pick-up points, drop-off points and parameters to each vehicle internet device.

10. A method for operating a carpool arranger comprising steps of
transmitting information from each potential passenger internet device and each vehicle internet device to a central processing module;
planning an optimal route for a passenger internet device that transmits a carpool request;
choosing appropriate vehicles;
planning carpool routes for the chosen vehicles; and
transmitting information from the central processing module to each potential passenger internet device and each vehicle internet device.

11. The method for operating a carpool arranger as claimed in claim 10, wherein the step of transmitting information from each passenger internet device and each vehicle internet device to a central processing module transmits carpool requests and pick-up point, drop-off point and parameters and information of vehicle position and status to the central processing module.

12. The method for operating a carpool arranger as claimed in claim 10, wherein the step of planning an optimal route for a passenger internet device that transmits a carpool request plans a route that has a starting point and an end point being respectively the pick-up point and drop-off point transmitted by the passenger internet device and has a minimum route length.

13. The method for operating a carpool arranger as claimed in claim 10, wherein the step of choosing appropriate vehicles chooses vehicles that carry passengers with vacancies and have routes such that each route contains the starting point of the optimal route and coincides with every point in the optimal route until the end point of the route.

14. The method for operating a carpool arranger as claimed in claim 10, wherein the step of choosing appropriate vehicles chooses vehicles that carry passengers without vacancies and have routes with end points near the starting point of the optimal route.

15. The method for operating a carpool arranger as claimed in claim 10, wherein the step of choosing appropriate vehicles chooses vehicles that are idle and have positions near the starting point of the optimal route such that passenger parameters such as number of passengers and vehicle type preferences transmitted by the user communication device can be satisfied.

16. The method for operating a carpool service system as claimed in claim 12, wherein the step of planning carpool routes for the chosen vehicles plans a carpool route for each chosen vehicle such that the planned carpool route is a union of the original route of the chosen vehicle, the optimal route and, if the vehicle are driving passengers without vacancies or idle, a route that connects the end point of the original route and the starting point of the optimal route.

17. The method for operating a carpool service system as claim in claim 11, wherein the step of transmitting information from the central processing module to the at least one passenger internet device and the at least one vehicle internet device transmits boarding position, boarding time, transportation fee, number of vacancies to each passenger device and a route, passenger pick-up point, drop-off point and parameters to each vehicle internet device.
